(19) United States
(12) Patent Application Publication
(10) Pub. No.: US 2006/0143915 A1
(43) Pub. Date: Jul. 6, 2006

(54) Brazeless connector for fluid transfer assemblies

(76) Inventors: Rafael L. Cleveland, Summerfield, FL (US); Terence E. Skiba, Ocala, FL (US); Herbert R. Lemaster, Ocala, FL (US)

Correspondence Address: DAYCO PRODUCTS, LLC, 1 PRESTIGE PLACE, MIAMISBURG, OH, 45342, US

(21) Appl. No.: 11/331,295

(22) Filed: Jan. 12, 2006

Related U.S. Application Data
(62) Division of application No. 10/170,749, filed on Jun. 13, 2002.

(51) Int. Cl. B23P 17/00

(52) U.S. Cl. 29/890.14

(57) ABSTRACT

An end fitting connector having an axial bore through which a fluid is conveyed; comprises: a stem portion which includes a first tubular body having a first annular rim disposed at a distal end of the first tubular body, wherein the distal end is adapted to be inserted into an inner channel of a fluid transport tube. The stem portion includes at least one annular sealing member extending circumferentially outward from an outer surface of the first tubular body; and a connector portion opposite the distal end of the first] tubular body. The connector portion includes a second tubular body having a second annular rim disposed at a distal end of the second tubular body, wherein the distal end of the second tubular body is adapted to be coupled with another fluid conveying structure.

### BACKGROUND OF THE INVENTION

The present invention relates to a coupling device for tubing connections and method for connecting tubes using such coupling devices. More specifically, the present invention relates to the connection of a metal fluid transfer tubing to other metallic connections without having to braze or weld the two pieces together.

Hose coupling devices are known. For example, U.S. Pat. No. 3,653,692 to Henson describes an elastomeric hose connected to a nipple having a circumferential barb. The hose is stretched allowing a ring member to slide down the hose and over the barbed nipple where it creates a compression of the hose when the hose is no longer stretched. U.S. Pat. No. 3,477,750 to Powell discloses a pipe section joined by a sleeve which includes annular teeth. The pipe is made of iron and the sleeve is preferably made of the same material. The design requires an additional sealing means in the form of a thin elastomeric membrane and further requires that the teeth be formed onto the pipe one at a time. U.S. Pat. No. 3,689,111 to Osmun; U.S. Pat. No. 5,707,087 to Ridenour et al.; U.S. Pat. No. 4,114,930 to Perkins et al.; and U.S. Pat. No. 5,423,581 to Salyers all teach coupling devices for connecting tubing to a fitting assembly to prevent leaks.

Current practice in the tube connector art requires that a heavy clamping or crimping force be applied about a collar around the tube and the fitting to provide a fluid-tight seal and to provide pull-off resistance to the assembly. In such cases, the tube is compressed radially inward to make a seal. However, it is difficult to make a permanent leak-tight seal, because the tube, even though malleable, tends to have sufficient elasticity to relax somewhat and deform, upon release of the clamping or crimping pressure just enough to compromise the fluid-tight seal, particularly, when the fluid is under high pressure for an extended period of time.

End connections on fluid transfer assemblies such as on power steering pressure and return lines require tight tolerances and high strength to prevent the fluid from leaking from the assembly. Conventional connectors are not able to achieve the required tolerances or the strength required to prevent such leaks. Typically, these connectors are brazed or welded to the fluid transfer tubing. When an assembly is brazed, it undergoes high temperatures which are generally detrimental to any coating or plating on the assembly or on the tubing. When steel or other low corrosion tolerance material is used as the assembly material, the assembly must be treated in order to protect it from the environment. Typical methods of protecting the assembly include pre-treatment of the assembly using electroplating and painting techniques. However, the high temperatures associated with conventional brazing or welding commonly causes the electroplating or painting to burn off during processing.

Therefore, it would be advantageous to have a connector for fluid transfer assemblies which eliminate the drawbacks of previously known connector assemblies.

### SUMMARY OF THE INVENTION

It is an object of the present invention to provide a tube, preferably a metal tube and connector assembly, preferably a metal connector assembly, and method for providing such assembly which is leak-free at high pressure for extended periods of time, whereby the need for welding or brazing a metal fluids transfer tubing to other metallic connections is eliminated.

In accordance with the present invention, a tube connector is used to connect a fluid transfer tubing to other metallic connections in a manner to provide a leak-free fluid transfer assembly. The tube connector comprising a rigid tubular member having an annular channel exhibiting an inner diameter extending along its longitudinal axis for transporting a fluid therethrough. The rigid tubular member comprises a first end portion, a second end portion and a tubular body portion. The tube connector further includes an axial bore which is adapted to convey a fluid therethrough. The first end portion includes a stem portion having a uniform outer surface diameter adapted to be inserted into an inner channel of a metal tubular structure, the stem portion having at least one sealing means extending uniformly outward from the outer surface diameter of the stem portion.

The second end portion includes a forward tubular structure which may or may not have a uniform outer diameter. The tubular body portion intermediate the first and second ends has an outer diameter larger than the second end. Typically, the rearward end of the tubular body portion has a surface perpendicular to the tubular portion of the second end forming a perpendicular shoulder against which the end of the metal tubular structure abuts upon insertion of the tube connector into the channel of the metal tubular structure, wherein the second end of the rigid tubular member is sealably secured to the metal connector by permanently and uniformly deforming the metal tubular structure under high pressure onto the sealing members.

In accordance with the present invention, a metal fitting pre-coated with a thin metallic coating such as zinc-nickel or zinc-cobalt is provided with one or more concentric annular metal barbs on the outer diameter of the metal fitting. The metal fitting is then loosely inserted into the end of the metal tube where the fitting is joined to the tube in a fluid-tight seal created by crimping, swaging, rolling or other means of permanently deforming the metal tube uniformly around the metal barbed fitting. The fluid-tight seal is created by the high pressure of the metal annular barbs pressed against the inner diameter of the metal tube, wherein the inner surface of the pre-coated metallic tube is permanently deformed corresponding to the configuration of the metal annular barbs on the metallic filling. The sealing is further enhanced by the permanent deformation of the inner diameter of the metal tube as it molds itself around the metal barbs, providing an intimate surface-to-surface relationship created between the two surfaces. In this respect, it is important that both the metal tube and the metal barbs on the fitting exhibit similar hardness and thermal expansion rate characteristics in order to create a leak free seal. Similar characteristics allow for the materials to flow and fill any voids or leak paths which may tend to form. The similar metallic materials also provide good leak resistance with respect to temperature and pressure variations.

### BRIEF DESCRIPTION OF THE DRAWING

FIG. 1 is a longitudinal view, in cross section of a tube connector of the present invention ready for assembly with a metal fluid transfer tube;

FIG. 2 is a longitudinal view, in cross section of a tube of the present invention assembled with a metal fluid transfer tube;

FIG. 3 is a longitudinal view, in a cross section of the tube of FIG. 2 wherein the tubular structure is compressed by a compressor means; and

FIG. 4 is a longitudinal view, in cross section of another embodiment of the present invention.

### DETAILED DESCRIPTION OF THE INVENTION

In accordance with the present invention, a metal tube connector is permanently coupled to a metal fluid transfer tube to provide a leak-free metal tube assembly, such as those used in automotive power steering assemblies, air conditioning assemblies, etc., without having to weld or braze the two pieces together. Since the present invention does not require the high temperatures associated with prior methods of coupling a metal connector to a metal tubing, the metal tubing may be pre-coated prior to making the assembly.

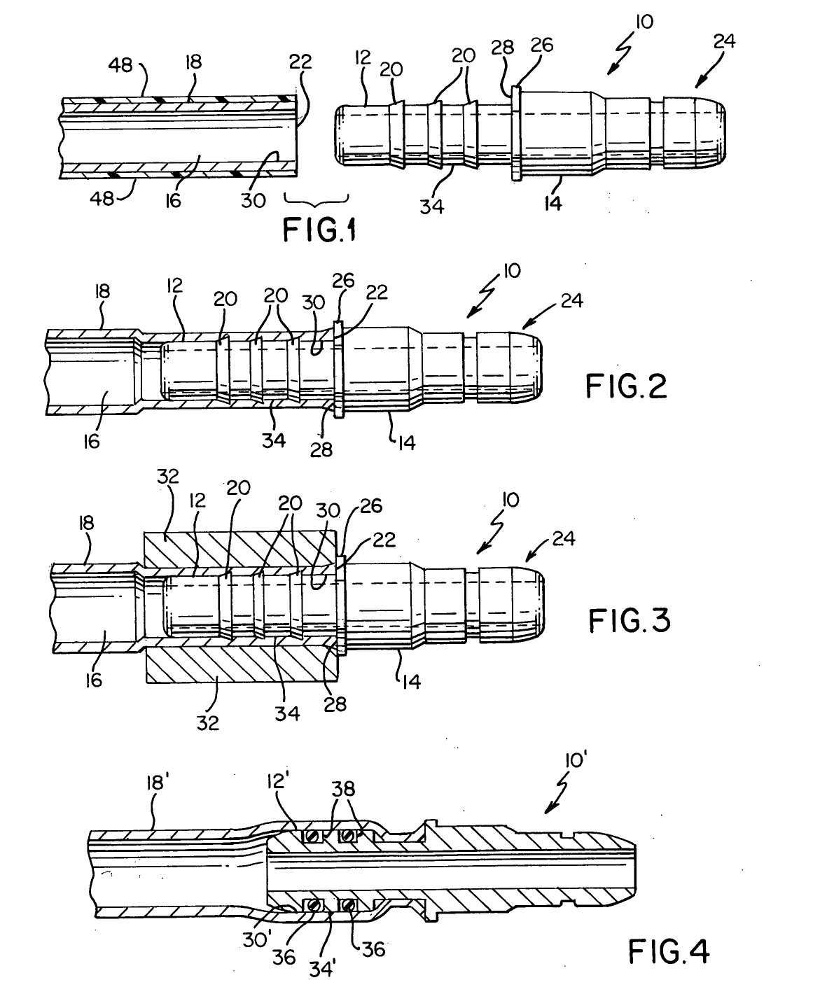

As illustrated in FIGS. 1-3, the metal end fitting 10 of a first embodiment of the present invention includes a stem portion 12 defining one end of the end fitting 10 and a coupling portion 14 defining another end of the end fitting 10. The stem portion 12 is adapted to be inserted into an end 22 of an inner channel 16 of a metal tubular structure 18 and secured thereto to provide a leak-free fitting.

The stem portion 12 includes one or more annular serrations or barbs 20 circumferentially disposed around the outer circumference of the stem portion 12. The stem portion 12 containing the serrations or barbs 20 is loosely inserted into the end 22 of the metal tubular structure 18 and subjected to crimping, swaging, rolling or other method of permanently deforming the metal tubing 18 uniformly onto the stem portion 12. The leak-free seal is created by the high pressure exerted upon the metal tubular structure 18 wherein the annular serrations or barbs 20 are pressed against and into the inner surface 30 of the metal tubular structure 18. The sealing is further enhanced by the permanent deformation of the inner diameter of the metal tubing 18 as it molds around the annular serrations or barbs 20, creating an intimate mating of both surfaces. It is essential that the metal tubular structure 18 and the serrations or barbs 20 have the same or similar characteristics such as hardness and thermal expansion rates in order for the seal to be leak-free. Similar hardness of the metal materials used in the metal tubular structure 18 and in the serrations or barbs 20 allow both metal materials to exhibit similar flow characteristics and, therefore, fill any potential voids or leak paths. Furthermore, both materials should have similar thermal expansion rates; otherwise, they may be prone to leaks upon being exposed to temperature variations. Typically, the metal tubular structure 18 is constructed of a low corrosion tolerance material, such as steel or the like which is pre-coated to prevent corrosion. Other materials having properties similar to the material used in forming the barbs may be employed to form the tubular structure.

The material used in manufacturing the tubular structure 18, the stem portion 12 and the serrations or barbs 20 of the present invention should be high quality and free of voids, pits, laps, cracks, folds, seams, slivers and other defects. When using these materials in the assemblies, they should be treated to protect the metal from the environment. Since connections made in accordance with the present invention do not require high temperatures, pre-treated metal tubes such as nylon-coated metal tubes, or metal tubes, which have been electroplated, painted or similarly treated, can be connected to an end fitting without the disadvantages associated with the prior art.

The serrations or barbs 20 on the stem portion 12 should be as sharp as the machining operation can make them to provide an adequate seal. It is also important that the serrations or barbs 20 be concentric to insure an even and constant penetration of the serrations or barbs 20 into the metal tubular structure 18 upon being crimped, swaged, rolled, etc under high pressure. The pressure needed to deform the tubular structure may be applied by suitable compression means 32 such as hydraulics, air-over-hydraulics, pneumatic or any other suitable method (see FIG. 3).

The shape of the serrations or barbs 20 is also important in providing the leak-free seal. The serrations or barbs 20 are tapered to extend outwardly from the outer surface 34 of stem portion 12, providing a forward rim defining a circumferential apex of an annular shoulder surface of the rim to provide a leak-free seal.

The number of serrations or barbs 20 present on the stem portion 12 is not critical. One serration or barb is sufficient in most applications; however, one may want to employ a plurality of serrations or barbs to provide backup seals in the assembly. Typically, two or three serrations or barbs are preferred.

The metal coupling portion 14 of the metal end fitting 10 includes a connecting portion 24 extending longitudinally outward from the stem portion 12. The connecting portion 24 connects the coupling portion 14 to a mated fitting (not shown). Typically, the connecting portion 14 includes flanged portion 26 adapted to receive a tool, such as a wrench, to hold the coupling portion 14 as the end fitting 10 is being connected to the mated fitting. The flanged portion 26 defines a rear shoulder surface 28. The connecting portion 24 can further include a threaded portion (not shown) extending longitudinally outward from the flanged portion 24. The threaded portion can comprise a male threaded portion or a female threaded portion. Additionally, the metal coupling portion 14 can include any suitable coupling mechanism, such as a quick disconnect and quick connect type fittings, or other types of conventional coupling mechanisms known in the art.

When the metal end fitting 10 is inserted into the metal tubular structure 18, the metal tubular structure 18 is compressed radially inward around the stem portion 12 of the end fitting 10 such that the inner channel 16 of the tubular structure 18 engages the serrations or barbs 20 providing a leak-free seal at each of the serrations or barbs 20. The serrations or barbs 20 not only provide leak-free seals but the also increase the pull-off resistance of the end fitting assembly 10.

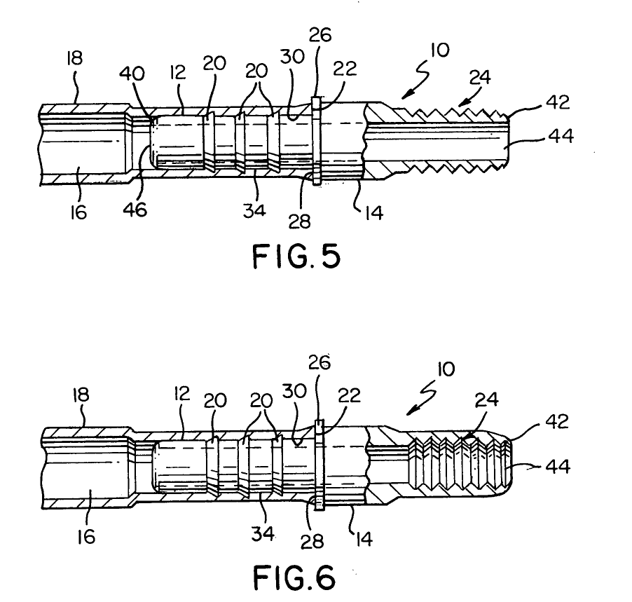

Another embodiment of the invention is shown ion FIG. 4, where the stem portion 12′ of end fitting 10′ includes one or more annular troughs 38 around the outer surface 34′ of the stem portion 12′ to provide a leak-free environment in an assembly. Each of the annular troughs 38 is adapted to contain an O-ring member 36, the outer diameter of which is slightly greater than the outer diameter of the stem portion 12′. The O-ring member 36 is made of a resilient material such as butyl rubber, nitrile-butadiene rubber, hydrogenated nitrile-butadiene rubber, silicone rubber, chlorosulfonated polyethylene (CSM), ethylene-propylene-diene rubber (EPDM) or other appropriate material for the fluid being retained.

When the stem portion 12′ is inserted into an open end of a metal tubular structure 18′ and then subjected to high pressure means, similar to that described above and shown in FIG. 3, to clamp the metal tubular structure 18′ around the stem 12′, the resilient O-rings 36 are compressed to form an intimate contact with the inner surface 30′ of the tubular structure 18′ as well as the annular trough 38 to provide a leak-free seal therein. This second embodiment of the invention allows one to use materials for the connector and the metal tubular structure which are not necessarily similar in hardness or have a thermal expansion rate. For example, in this embodiment the metal connector may be made of steel and the metal tubular structure may be aluminum or vice versa.

Although the present invention has been fully described in connection with a preferred embodiment thereof and with reference to the accompanying drawing, various changes and modifications will occur to those skilled in the art. Accordingly, such changes and modifications are to be understood as being within the scope of the present invention as defined by the appended claims.

What is claimed is:

1-36. (canceled)

37. A method for forming a leak-tight seal between a fluid transfer tube and an end fitting connector, said method comprising:
1. providing an end fitting connector having an axial bore extending therein, said end fitting connector comprising:
a. a stem portion having a first end having an outer surface exhibiting a uniform circumference, said stem portion including one or more annular sealing members on said outer surface of said stem portion, and a first annular rim at a proximal end thereof, said first annular rim defining a first orifice of said axial bore,
b. a connecting portion opposite said stem portion, said connecting portion having a second rim defining a second orifice of said axial bore, and
c. a flanged portion intermediate said stem portion and said connecting portion, said flanged portion extending circumferentially perpendicular to said rigid end fitting connector, said flanged portion having a shoulder surface facing said stem portion;
2. providing a fluid transport tube having an outer surface and an inner surface, said inner surface defining an axial bore through which said fluid is transported, and an end portion configured to receive said stem portion of said end fitting connector;
3. inserting said stem portion of said end fitting connector into said end portion of said fluid transport tube such that said first annular rim of said fluid transport tube abuts said shoulder surface; and
4. compressing said fluid transport tube onto said end fitting connector at a pressure sufficient to cause said fluid transport tube to deform and mold around said one or more sealing members, thereby providing a leak-free seal between said fluid transport tube and said end fitting connector.

38. The method of claim 37, wherein said one or more annular sealing members comprises one or more metal barbs integral with and extending circumferentially outward from said outer surface of said stem portion.

39. The method of claim 38, wherein each of said one or more metal barbs comprises a forward rim exhibiting a sharp edge defining a circumferential apex of an annular shoulder surface of said each of said metal barbs.

40. The method of claim 38, wherein said metal barbs and said fluid transport tube are made of metals having similar flow characteristics and similar thermal expansion rates.

41. The method of claim 38, wherein said one or more metal barbs and said fluid transport tube are made of steel.

42. The method of claim 38, wherein said step of compressing said end portion of said fluid transport tube is conducted at a sufficiently high concentric pressure to cause said fluid transport tube to mold around said one or more sealing members thereby providing a leak-free seal between said rigid fluid transport tube and said rigid end fitting connector.

43. The method of claim 37, further comprising the step of pre-coating said end fitting connector with a zinc-nickel coating or a zinc-cobalt coating.

44. The method of claim 37, further comprising the step of pre-coating said fluid transport tube with nylon.

45. The method of claim 37, wherein said one or more annular sealing members comprises one or more annular collars selected from the group consisting of butyl rubber, nitrile-butadiene rubber, hydrogenated nitrile-butadiene rubber, silicone rubber, chlorosulfonated polyethylene and ethylene-propylene-diene rubber, wherein each of said annular collars is seated in a corresponding groove disposed circumferentially around said outer surface of said stem portion.

46. The method of claim 45 wherein said end fitting connector and said fluid transport tube are made of metal.

47. The method of claim 45, wherein said end fitting connector is made of steel and said fluid transport tube is made of aluminum.

48. A method for forming a leak-free seal between a metal fluid transport tube and a metal end fitting connector, said method comprising:
1. providing a metal end fitting connector having an axial bore extending therein, said metal end fitting comprising:
a. a stem portion having a first end having an outer surface exhibiting a uniform circumference, said stem portion including one or more annular metal barbs integral with and extending circumferentially outward from said outer surface of said stem portion, and a first annular rim at a proximal end thereof, said first annular rim defining a first orifice of said axial bore,
b. a connecting portion opposite said stem portion, said connecting portion having a second rim defining a second orifice of said axial bore, and
c. a flanged portion intermediate said stem portion and said connecting portion, said flanged portion extending circumferentially perpendicular to said rigid end fitting connector, said flanged portion having a shoulder surface facing said stem portion;
2. providing a metal fluid transport tube having an outer surface and an inner surface, said inner surface defining an axial bore through which said fluid is transported, and an end portion configured to receive said stem portion of said metal end fitting connector;
3. inserting said stem portion of said metal end fitting connector into said end portion of said metal fluid transport tube such that said first annular rim of said metal fluid transport tube abuts said shoulder surface; and
4. compressing said metal fluid transport tube onto said metal end fitting connector at a pressure sufficient to cause said first metal fluid transport tube to deform and mold around said one or more metal barbs thereby creating a leak-free seal between said metal fluid transport tube and said metal end fitting connector.

49. The method of claim 48, wherein each of said one or more metal barbs comprises a forward rim exhibiting a sharp edge defining a circumferential apex of an annular shoulder surface of said each of said metal barbs.

50. The method of claim 48, wherein said one or more metal barbs and said fluid transport tube are made of metals having similar flow characteristics and similar thermal expansion rates.

51. The method of claim 48, wherein said metal barbs and said fluid transport tube are made of steel.

52. The method of claim 48, further comprising the step of pre-coating said metal end fitting connector with a zinc-nickel coating or a zinc-cobalt coating.

53. The method of claim 48, further comprising the step of pre-coating said metal fluid transport tube with nylon.
